(19) United States
(12) Patent Application Publication
(10) Pub. No.: US 2025/0277932 A1
(43) Pub. Date: Sep. 4, 2025

(54) OPTICAL FIBER ELEMENT WIRE AND MANUFACTURING METHOD OF OPTICAL FIBER RIBBON

(71) Applicant: Fujikura Ltd., Tokyo (JP)

(72) Inventors: Akira Murata, Sakura-shi (JP); Miku Miyata, Sakura-shi (JP)

(73) Assignee: Fujikura Ltd., Tokyo (JP)

(21) Appl. No.: 18/859,038

(22) PCT Filed: Apr. 20, 2023
(86) PCT No.: PCT/JP2023/015809

§ 371 Date: Oct. 22, 2024

Related U.S. Application Data
(60) Provisional application No. 63/334,670, filed on Apr. 26, 2022.

(51) Int. Cl. G02B 6/02; C03C 25/1065; G02B 6/44

(52) U.S. Cl. CPC G02B 6/02323; C03C 25/1065; G02B 6/448

(57) ABSTRACT

An optical fiber element wire includes: a bare wire part including a core and a cladding and extending in an axial direction of the bare wire part; a primary layer covering the bare wire part; and a secondary layer covering the primary layer. A Young's modulus of the primary layer is within a predetermined range that removes a void within the primary layer in response to the optical fiber element wire being heated at either 45° C. or 60° C. for 3 minutes or more.

### TECHNICAL FIELD

The present invention relates to an optical fiber element wire and a manufacturing method of an optical fiber ribbon.

Priority is claimed on United States Patent Application, Publication No. 63/334,670 filed in the United States on Apr. 26, 2022, the content of which is incorporated herein by reference.

### BACKGROUND

Conventionally, an optical fiber element wire such as that described in Japanese Unexamined Patent Application, First Publication No. 2005-189390 is known. This optical fiber element wire includes a bare wire part including a core and a cladding, a primary layer covering the bare wire part, and a secondary layer covering the primary layer.

When an optical fiber element wire is manufactured, or when an optical fiber ribbon or an optical fiber cable is manufactured using the optical fiber element wire, a pressure (lateral pressure) in a radial direction may be applied to the optical fiber element wire. For example, when the drawn optical fiber element wire is wound around a bobbin, the optical fiber element wire may be sandwiched between a take-up belt and a capstan, or the optical fiber element wires may overlap each other. Therefore, a compressive force is applied to the optical fiber element wire. When the pressure as described above is applied to the optical fiber element wire, there is a likelihood that voids will occur within the primary layer. Occurrence of the voids in the optical fiber element wire may result in an increase in transmission loss in the optical fiber element wire, and in an optical fiber ribbon or an optical fiber cable that uses the optical fiber element wire.

### SUMMARY

One or more embodiments of the present invention provide an optical fiber element wire and a manufacturing method of an optical fiber ribbon in which transmission loss is less likely to increase.

An optical fiber element wire according to one aspect of the present invention includes a bare wire part including a core and a cladding and extending in an axial direction, a primary layer covering the bare wire part, and a secondary layer covering the primary layer, in which a Young's modulus of the primary layer is within a range of 0.10 to 0.25 MPa, and the optical fiber element wire is configured such that a void occurring within the primary layer disappears when the optical fiber element wire is heated at 60° C. for 3 minutes or more.

According to the above-described aspect of the present invention, it is possible to provide an optical fiber element wire and a manufacturing method of an optical fiber ribbon in which transmission loss is less likely to increase.

### BRIEF DESCRIPTION OF THE DRAWINGS

FIG. 1 is a perspective view illustrating an optical fiber element wire according to one or more embodiments.

FIG. 2 is a cross-sectional view taken along line II-II indicated by the arrow illustrated in FIG. 1.

FIG. 3 is a cross-sectional view taken along line III-III indicated by the arrow illustrated in FIG. 2, and is a view illustrating peeling, a void, and a crack.

FIG. 4 is a view illustrating an example of a method of measuring a Young's modulus of a primary layer.

### DETAILED DESCRIPTION

Hereinafter, an optical fiber element wire 1 according to one or more embodiments will be described with reference to the drawings.

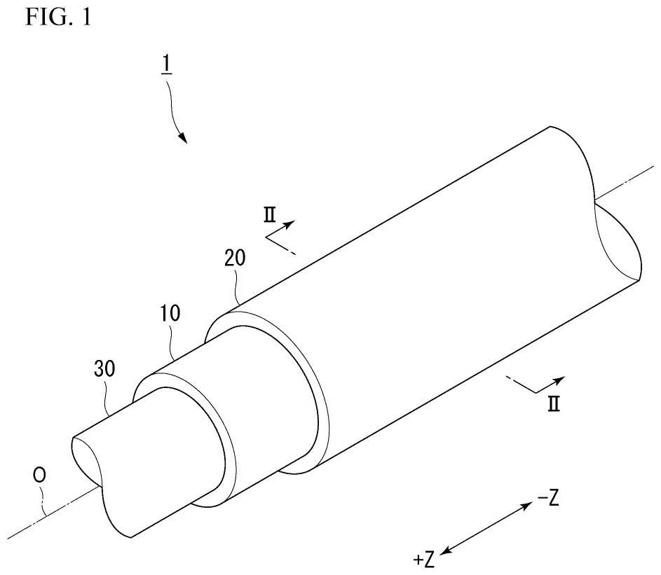

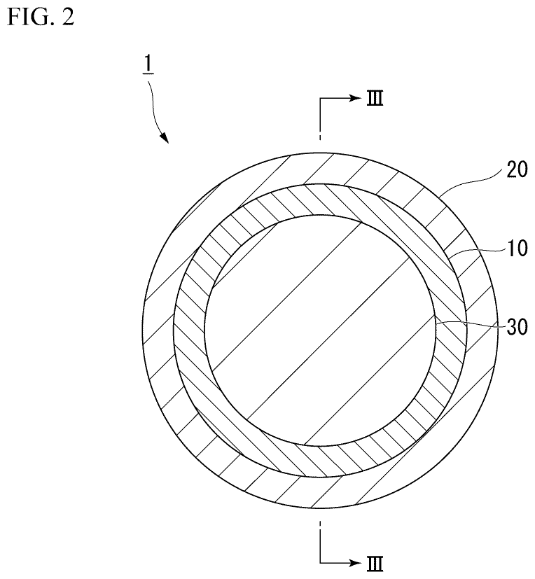

As illustrated in FIGS. 1 and 2, the optical fiber element wire 1 includes a bare wire part 30, a primary layer 10, and a secondary layer 20. A drawing speed when the optical fiber element wire 1 is drawn may be within a range of, for example, 1800 to 3000 m/min.

### Definition of Directions

Here, in one or more embodiments, a direction parallel to a central axis O of the bare wire part 30 is referred to as a Z direction or an axial direction Z. A cross section perpendicular to the axial direction Z is referred to as a cross section. A direction orthogonal to the central axis O of the bare wire part 30 is referred to as a radial direction. A direction approaching the central axis O in the radial direction is referred to as a radially inward direction, and a direction away from the central axis O is referred to as a radially outward direction. A direction of revolving around the central axis O when viewed from the axial direction Z is referred to as a circumferential direction.

The bare wire part 30 extends in the axial direction Z. The bare wire part 30 includes a core and a cladding. The bare wire part 30 is formed of, for example, glass. In this case, the bare wire part 30 is also referred to as a glass part 30. A refractive index of the core is higher than a refractive index of the cladding. With this configuration, light is confined within the core, and the light propagates within the bare wire part 30 in the axial direction Z. An outer diameter of the bare wire part 30 is, for example, about 125 μm. However, the outer diameter of the bare wire part 30 may be 100 μm or less. Alternatively, the outer diameter of the bare wire part 30may be 80 μm or less.

The primary layer 10 is also referred to as a first coating layer 10. The primary layer 10 extends in the axial direction Z. The primary layer 10 covers the bare wire part 30 from the outside in the radial direction. A material of the primary layer 10 is, for example, a UV curable acrylate resin. More specifically, as the material for the primary layer 10, a material with an appropriate combination of, for example, various monomers and oligomers such as urethane (meth) acrylate, epoxy (meth) acrylate, polyester acrylate, polyether, and polyamide, a UV-curable resin composition, reactive diluents, polymerization initiators for these materials, silane coupling agents that enhance an adhesive strength with the bare wire part, and the like may be used. A Young's modulus of the primary layer 10 according to one or more embodiments is within a range of 0.10 to 0.25 MPa. For example, if the outer diameter of the bare wire part 30 is about 125 μm and an outer diameter of the secondary layer 20 is 200 μm or less, a thickness of the primary layer 10 is about 11 to 22 μm, or 13 to 19 μm.

The secondary layer 20 is also referred to as a second coating layer 20. The secondary layer 20 extends in the axial direction Z. The secondary layer 20 covers the primary layer 10 from the outside in the radial direction. A material of the secondary layer 20 is, for example, a UV curable acrylate resin. More specifically, as the material for the secondary layer 20, a material with an appropriate combination of, for example, various monomers and oligomers such as urethane (meth)acrylate, epoxy (meth)acrylate, polyester acrylate, polyether, and polyamide, a UV-curable resin composition, reactive diluents, and polymerization initiators for these materials may be used. A Young's modulus of the secondary layer 20 may be within, for example, a range of 750 to 2000 MPa, or 750 to 1400 MPa. A glass transition temperature of the secondary layer 20 may be within, for example, a range of 60 to 110° C., or 70 to 100° C. For example, when the outer diameter of the bare wire part 30 is about 125 μm and the outer diameter of the secondary layer 20 is 200 μm or less, the thickness of the primary layer 10 is about 11 to 22 μm, or 13 to 19 μm. The primary layer 10 and the bare wire part 30 are chemically adhered.

Next, an operation of the optical fiber element wire 1 configured as above will be described.

When the optical fiber element wire 1 is manufactured or when an optical fiber ribbon or an optical fiber cable is manufactured using the optical fiber element wire 1, a pressure (lateral pressure) in the radial direction may be applied to the optical fiber element wire 1. For example, when the drawn optical fiber element wire 1 is wound around a bobbin, since the optical fiber element wires 1 overlap each other, a compressive stress is applied to the optical fiber element wire 1. Also, when the optical fiber element wire 1 is sandwiched between a substrate and a belt to pull out the optical fiber element wire 1, a compressive stress is also applied to the optical fiber element wire 1. In these cases, a tensile stress occurs in the optical fiber element wire 1 in a direction (axial direction Z) perpendicular to a direction in which the compressive stress acts.

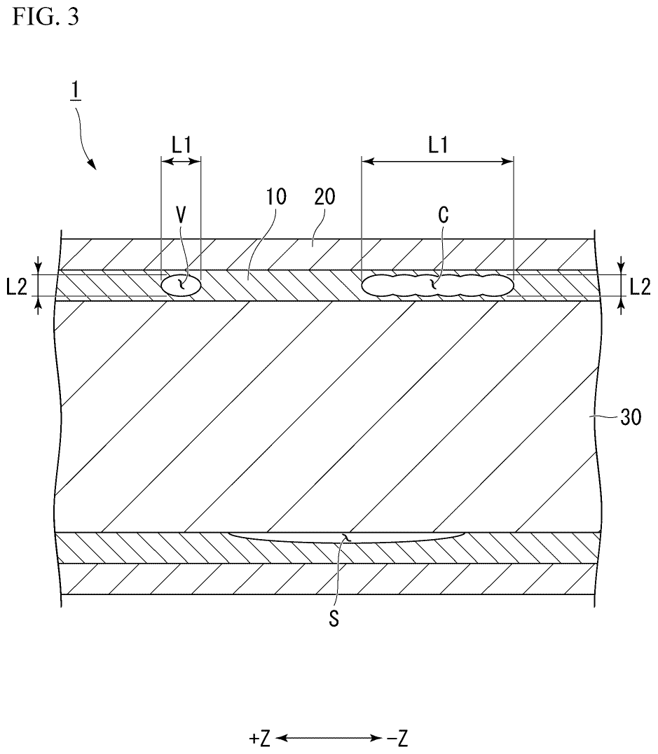

If the pressure as described above is applied to the optical fiber element wire 1, a void V may occur in the primary layer 10 of the optical fiber element wire 1 (see FIG. 3). The void V is a space that occurs within the primary layer 10. The void V occurs due to both the stress applied to the optical fiber element wire 1 and a residual stress inherent in the optical fiber element wire 1 itself. The void V may be formed when a microscopic space inherent in the primary layer 10 is pushed to extend by the above-described stress. The void V is not in contact with the bare wire part 30, and the adhesive strength between the bare wire part 30 and the primary layer 10 is maintained. Once the void V occurs, it does not disappear even after the applied stress is removed due to an influence of the residual stress. More specifically, the void V is defined as a space occurring within the primary layer 10 in which a dimension L1 in the axial direction Z is three times or less a dimension L2 in the radial direction. That is, for the void V, it holds that L1≤3×L2.

Occurrence of the void V in the optical fiber element wire 1 may lead to an increase in transmission loss of the optical fiber element wire 1. This is because, if the void V occurs within the optical fiber element wire 1, the primary layer 10 becomes non-uniform, which has adverse effects on the bare wire part 30 such as occurrence of bending. Particularly, if the optical fiber element wire 1 is cooled, the primary layer 10 becomes hard and contracts non-uniformly, making it likely to cause adverse effects such as occurrence of bending in the bare wire part 30. Thereby, the transmission loss of the optical fiber element wire 1 is more likely to increase.

As a result of intensive studies of the inventors of the present application, it have found that, for the optical fiber element wire 1 according to one or more embodiments, by setting the Young's modulus of the primary layer 10 within the above-described range, even if the void V occurs within the primary layer 10, it is possible to make the void V to disappear by heating the optical fiber element wire 1 at 60° C. for 3 minutes or more. That is, the inventors of the present application have found that, even if the void V has occurred inside the optical fiber element wire 1 according to one or more embodiments during a manufacturing stage, a distribution stage, or the like, it is possible to suppress an increase in transmission loss of the optical fiber element wire 1 by heating the optical fiber element wire 1.

The void V disappearing due to heating is considered to be because an influence of the stress applied to the primary layer 10 and the residual stress inherent in the optical fiber element wire 1 are alleviated by heat. In addition, the residual stress, once alleviated, is not restored even when the optical fiber element wire 1 is cooled. Therefore, the void V that has disappeared due to heating does not reoccur even if the optical fiber element wire 1 is cooled.

Note that, if the pressure applied to the optical fiber element wire 1 is too large, a crack C or peeling may occur in the primary layer 10 (see FIG. 3). Peeling is a phenomenon in which the adhesion between the primary layer 10 and the bare wire part 30 is partially dissolved. When the peeling occurs, a gap S is generated between the primary layer 10 and the bare wire part 30 as illustrated in FIG. 3. Similarly to the void V, the crack C is a space that occurs within the primary layer 10. The crack C has a shape such that the void Vis continuous in the longitudinal direction Z of the optical fiber element wire 1. The crack C is defined as a space occurring within the primary layer 10 in which the dimension L1 in the axial direction Z is larger than three times the dimension L2 in the radial direction. That is, for the crack C, L1>3×L2 holds. The void V and the crack C are spaces that occur within the primary layer 10. If the applied stress is too large, and the bare wire part 30 and the primary layer 10 are firmly adhered to each other, not only are the microscopic spaces inherent in the primary layer 10 pushed to extend, but the bonds may also be broken. The extension of the microscopic spaces accompanied by the breaking of the bonds becomes the crack C.

An optical fiber ribbon may be manufactured by preparing a plurality of optical fiber element wires 1 according to one or more embodiments. Note that, the term “optical fiber ribbon” refers to a tape-shaped (ribbon-shaped) member in which the plurality of optical fiber element wires 1 are arranged in a direction perpendicular to the axial direction Z and integrated together. When the optical fiber ribbon is manufactured using the optical fiber element wires 1, a coloring step and a ribbon forming step are performed. The coloring step is a step of providing a colored layer on the optical fiber element wire 1 using a coloring agent. The ribbon forming step is a step in which a ribbon forming material is applied to the plurality of optical fiber element wires 1, and the plurality of optical fiber element wires 1 are integrated into a ribbon shape by heating and curing the ribbon forming material. Note that, the ribbon forming material may be a plurality of connection parts that intermittently connect the plurality of optical fiber element wires 1 in the axial direction Z. The optical fiber ribbon in this case is a so-called intermittently-fixed optical fiber ribbon. Alternatively, the ribbon forming material may be a coating material that collectively covers the plurality of optical fiber element wires 1. Also, an optical fiber cable may be manufactured using the optical fiber element wires 1 according to one or more embodiments. When an optical fiber cable is manufactured using the optical fiber element wires 1, a cabling step in which the optical fiber element wires 1 (optical fiber ribbon) are covered with an outer sheath material (sheath) is performed.

In these steps, heat is applied to the optical fiber element wires 1. That is, in the optical fiber ribbon or the optical fiber cable which is a final form of use, the optical fiber element wire 1 has a thermal history associated with manufacture of the optical fiber ribbon or manufacture of the optical fiber cable. Hereinafter, heat to which the optical fiber element wire 1 is subjected during manufacturing processes of the optical fiber ribbon and the optical fiber cable using the optical fiber element wire 1 will be specifically described.

The coloring agent used in the above-described coloring step and the ribbon forming material used in the above-described ribbon forming step are both a UV curable resin. In each of the coloring step and the ribbon forming step, a UV curable resin (coloring agent, ribbon forming material) is applied to the optical fiber element wires 1, and then the optical fiber element wires 1 are irradiated with light from a metal halide lamp or a UV LED to induce a cross-linking reaction. Thereby, formation of the colored layer or integration (ribbon forming) of the optical fiber element wires 1 are performed. Here, the inside of an ultraviolet lamp generally reaches a high temperature of several hundreds of degrees Celsius due to radiant heat. Therefore, the optical fiber element wires 1 are exposed to a high temperature inside the ultraviolet lamp both in the coloring step and in the ribbon forming step. Also, the cross-linking reaction is an exothermic reaction. Therefore, during curing, the optical fiber element wire 1 is wound around the bobbin in a high temperature state.

Also, a thermoplastic resin is used as the outer sheath material for the optical fiber cable. In the cabling step, the thermoplastic resin is heated to 120° C. or higher to be processed. Therefore, the optical fiber element wire 1 housed within the heated thermoplastic resin is exposed to a high temperature.

Therefore, whether the optical fiber element wire 1 is productized as an optical fiber ribbon or the optical fiber element wire 1 is productized as an optical fiber cable, the optical fiber element wire 1 is exposed to a high temperature. Therefore, there is a high likelihood that the optical fiber element wire 1, which has been productized as an optical fiber ribbon or an optical fiber cable, has a thermal history equivalent to, for example, about 60° C. for three minutes. According to the optical fiber element wire 1 of one or more embodiments, it is also possible to make the void V disappear by utilizing the heat during each of the above-described steps in the manufacture of the optical fiber ribbon and the manufacture of the optical fiber cable.

### EXAMPLES

Hereinafter, the above-described embodiments will be described using specific examples. Note that, the present invention is not limited to the following examples.

A total of 14 optical fiber element wires consisting of examples 1 to 12 and comparative examples 1 and 2 were prepared. Examples 1 to 12 are the optical fiber element wires 1 described in the above-described embodiments. Examples 1 to 12 and comparative examples 1 and 2 differ from one another in outer diameter of the optical fiber element wire, outer diameter of the primary layer, Young's modulus of the primary layer, and Young's modulus of the secondary layer. Table 1 is a table in which examples 1 to 12 and comparative examples 1 and 2 are summarized. In each of examples 1 to 12 and comparative examples 1 and 2, a glass transition temperature of the secondary layer was 85° C. and a drawing speed during drawing was 2500 m/min. The glass 10 transition temperature was measured by a dynamic mechanical analysis (DMA) at 1 Hz.

TABLE 1

| | Outer | Outer | Young's | Young's | | | | | | |
|---|---|---|---|---|---|---|---|---|---|---|
| | diameter | diameter | modulus | modulus | Void | | | | | |
| | of element | of primary | of primary | of secondary | occurrence | | | Increase in | Increase in | Cable |
| | wire | layer | layer | layer | load | Heating | Void | element wire | element wire | transmission |
| | [μm] | [μm] | [MPa] | [MPa] | [g] | condition | disappearance | loss A | loss B | loss |
| Example 1 | 185 | 151 | 0.17 | 1250 | 500 | 60° C., | Disappeared | Satisfactory | Satisfactory | Satisfactory |
| | | | | | | 3 minutes | | | | |
| Example 2 | 185 | 151 | 0.17 | 1250 | 600 | 60° C., | Disappeared | Poor | Satisfactory | Satisfactory |
| | | | | | | 3 minutes | | | | |
| Example 3 | 185 | 151 | 0.17 | 1250 | 700 | 60° C., | Disappeared | Poor | Satisfactory | Satisfactory |
| | | | | | | 3 minutes | | | | |
| Example 4 | 185 | 151 | 0.17 | 1250 | 500 | 45° C., | Disappeared | Satisfactory | Satisfactory | Satisfactory |
| | | | | | | 3 minutes | | | | |
| Example 5 | 185 | 151 | 0.17 | 1250 | 600 | 45° C., | Disappeared | Poor | Satisfactory | Satisfactory |
| | | | | | | 3 minutes | | | | |
| Example 6 | 193 | 157 | 0.17 | 1250 | 500 | 60° C., | Disappeared | Satisfactory | Satisfactory | Satisfactory |
| | | | | | | 3 minutes | | | | |
| Example 7 | 193 | 157 | 0.17 | 1250 | 600 | 60° C., | Disappeared | Poor | Satisfactory | Satisfactory |
| | | | | | | 3 minutes | | | | |
| Example 8 | 193 | 157 | 0.17 | 1250 | 700 | 60° C., | Disappeared | Poor | Satisfactory | Satisfactory |
| | | | | | | 3 minutes | | | | |
| Example 9 | 185 | 151 | 0.1 | 1250 | 600 | 60° C., | Disappeared | Poor | Satisfactory | Satisfactory |
| | | | | | | 3 minutes | | | | |
| Example 10 | 185 | 151 | 0.25 | 1250 | 600 | 60° C., | Disappeared | Poor | Satisfactory | Satisfactory |
| | | | | | | 3 minutes | | | | |
| Example 11 | 185 | 151 | 0.1 | 1250 | 600 | 45° C., | Disappeared | Poor | Satisfactory | Satisfactory |
| | | | | | | 3 minutes | | | | |
| Example 12 | 185 | 151 | 0.25 | 1250 | 600 | 45° C., | Disappeared | Poor | Satisfactory | Satisfactory |
| | | | | | | 3 minutes | | | | |
| Comparative | 185 | 155 | 0.08 | 1250 | 600 | 60° C., | Not | Poor | Poor | Poor |
| example 1 | | | | | | 3 minutes | disappeared | | | |
| Comparative | 185 | 155 | 0.25 | 1250 | 600 | 60° C., | Not | Poor | Poor | Poor |
| example 2 | | | | | | 3 minutes | disappeared | | | |

The Young's modulus of the primary layer was measured in a state of the optical fiber element wire, that is, in a state in which the primary layer, together with the bare wire part and the secondary layer, forms the optical fiber element wire. The Young's modulus of the primary layer was measured in a shear mode.

Similarly, the Young's modulus of the secondary layer was measured in a state of the optical fiber element wire. The Young's modulus of the secondary layer was measured in a tensile mode by separating the coating material from the optical fiber element wire.

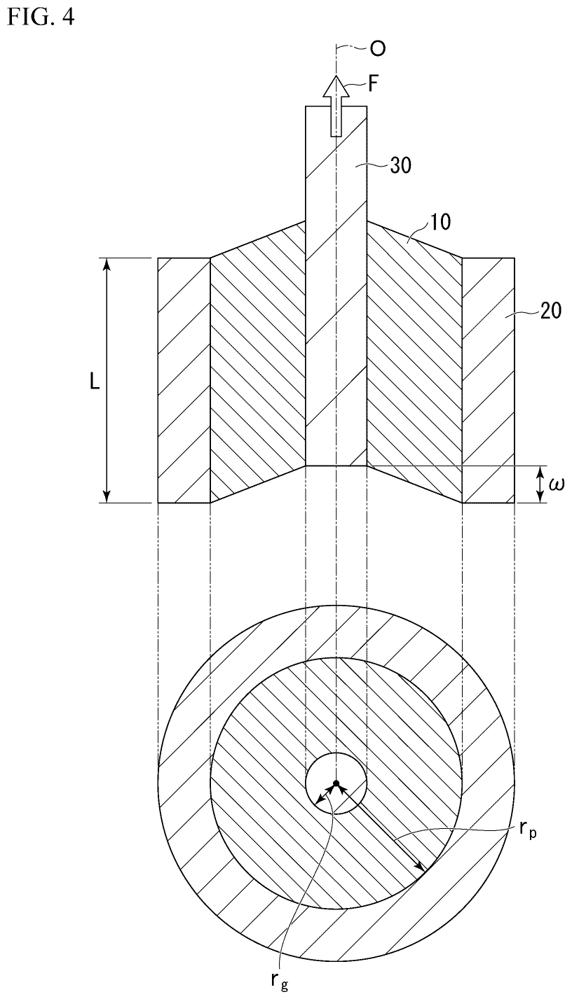

Note that, the Young's modulus (shear mode) of the primary layer was measured, more specifically, by a TMA method in an environment of 25° C. That is, as illustrated in FIG. 4, the bare wire part was exposed while leaving parts of the primary layer and the secondary layer. Thereafter, the secondary layer was fixed, the bare wire part was pulled in the axial direction, and a tensile load and an amount of displacement of the bare wire part were measured. Provided that the tensile load is F and the amount of displacement of the bare wire part is ω, it is possible to determine a Young's modulus G of the primary layer by the following mathematical expression (1). Note that, in mathematical expression (1), rg is a radius of the bare wire part, rp is a radius of the primary layer, and L is a length of the secondary layer in the axial direction (see FIG. 4).

$$\begin{matrix}[ Math . 1 ] & \\ G = \frac{3 F}{4 π L ω} ln \frac{{r}_{p}}{{r}_{g}} & ( 1 )\end{matrix}$$

The following experiment was conducted for the 14 optical fiber element wires shown in Table 1.

First, a plurality of voids V were caused to occur intermittently in the axial direction Z of the optical fiber element wire 1 by conducting a fatigue test on each of the optical fiber element wires. More specifically, with a tension applied to the optical fiber element wire, the optical fiber element wire was pressed against a mandrel having a diameter of 8 mm, and the optical fiber element wire was continuously deformed. The “void occurrence load” in Table 1 means a load (tension) applied to the optical fiber element wire during the fatigue test. Note that, as described above, when an excessive load is applied to the optical fiber element wire, the crack C or peeling occurs. Therefore, a magnitude of the load applied to the optical fiber element wire during the fatigue test was appropriately adjusted so that a crack or peeling did not occur and only the void V occurred in the optical fiber element wire. A magnitude of the tension applied to the optical fiber element wire is shown in Table 1 as the “void occurrence load”.

Next, transmission loss of the optical fiber element wire was evaluated under the conditions of the standard IEC60793-1-51. More specifically, light with a wavelength of 1550 nm generated from an LD light source was incident on an optical fiber element wire having a length of 2000 m. Then, power of the light was monitored to determine a difference between a transmission loss at room temperature and a transmission loss at −60° C. Thereby, a degree to which the transmission loss of the optical fiber element wire increased at −60° C. compared to that at room temperature was evaluated.

Here, in the above-described evaluation, measurement of the difference in transmission loss was performed by the following two methods. A method A is a method that measures a difference between a transmission loss of the optical fiber element wire at room temperature and a transmission loss of the optical fiber element wire cooled from room temperature to −60° C. without being subjected to a high temperature. A method B is a method that measures a difference between a transmission loss of the optical fiber element wire at room temperature and a transmission loss of the optical fiber element wire heated from room temperature for a predetermined time and to a predetermined temperature and then cooled to −60° C. In Table 1, the results of the evaluation based on the difference in transmission loss measured by the method A are expressed as an “increase in primary coated fiber loss A,” and the results of the evaluation based on the difference in transmission loss measured by the method B are expressed as an “increase in primary coated fiber loss B”. The evaluation results were classified as “poor” when the transmission loss at −60° C. increased by 0.001 dB or more compared to that at room temperature, and as “satisfactory when the increase in transmission loss was less than 0.001 dB.

Note that, the temperature and heating time when the primary coated fiber was heated in the method B are shown in Table 1 as “heating conditions”.

Next, presence or absence of the void V was observed for the optical fiber element wire that had been heated and cooled by the above-described method B. That is, it was observed whether or not the void V disappeared due to heating. The observation was conducted by immersing each optical fiber element wire in a matching oil and then observing the immersed optical fiber element wire under a microscope.

Also, in addition to the above-described evaluation of the increase in transmission loss of the optical fiber element wires, optical fiber cables were manufactured using the optical fiber element wires that had been subjected to the above-described fatigue test, and transmission loss of the optical fiber cables was measured. In Table 1, if a magnitude of the transmission loss was less than a predetermined value, a “cable transmission loss” was classified as “satisfactory,” and if the magnitude of the transmission loss was equal to or larger than the predetermined value, the “cable transmission loss” was classified as “poor”.

As shown in Table 1, in the optical fiber element wires according to examples 1 to 12 (the optical fiber element wire 1 according to the above-described embodiments), the Young's modulus of the primary layer is within a range of 0.10 to 0.25 MPa. Then, in the optical fiber element wires according to examples 1 to 12, the void V disappeared with heating at 60° C. for 3 minutes or at 45° C. for 3 minutes. That is, when the Young's modulus of the primary layer in the optical fiber element wire 1 according to the above-described embodiments is set within the range of 0.10 to 0.25 MPa, it is possible to realize a configuration in which the void V disappears with heating at 60° C. for 3 minutes or at 45° C. for 3 minutes.

Also, in the optical fiber element wires according to examples 1 to 12, regardless of whether the increase in primary coated fiber loss A is satisfactory or poor, the increase in primary coated fiber loss B is satisfactory. This means that it is possible to improve the transmission loss of the optical fiber element wire by making the void V disappear by heating. Note that, the increase in primary coated fiber loss A being satisfactory in the optical fiber element wires according to examples 1, 4, and 6 is considered to be because the void V occurred in the optical fiber element wire was sufficiently small. Also, the transmission loss is satisfactory also for the optical fiber cables using the optical fiber element wires according to examples 1 to 12. This means that, when the optical fiber cable is manufactured using the optical fiber element wire 1 according to the above-described embodiments, it is possible to make the void V to disappear by the heat in the manufacturing process of the optical fiber cable, and it is possible to suppress an increase in transmission loss.

On the other hand, in the optical fiber element wires according to comparative examples 1 and 2, the void V has not disappeared. This is considered to be because the Young's modulus of the primary layer in the optical fiber element wire according to comparative example 1 is too small, and the Young's modulus of the primary layer in the optical fiber element wire according to comparative example 2 is too large.

As described above, the optical fiber element wire 1 according to one or more embodiments includes the bare wire part 30 having a core and a cladding and extending in the axial direction Z, the primary layer 10 covering the bare wire part 30, and the secondary layer 20 covering the primary layer 10, in which the Young's modulus of the primary layer 10 is within a range of 0.10 to 0.25 MPa, and the optical fiber element wire 1 is configured such that the void V occurring within the primary layer 10 disappears when the optical fiber element wire 1 is heated at 60° C. for 3 minutes or more.

According to this configuration, even if the void V has occurred in the optical fiber element wire 1 during a manufacturing stage or a distribution stage, it is possible to make the void V which causes transmission loss in the optical fiber element wire 1 to disappear by heating the optical fiber element wire 1 at 60° C. for three minutes or more. That is, it is possible to suppress an increase in transmission loss of the optical fiber element wire 1.

Also, the optical fiber element wire 1 may be configured such that the void V disappears when the optical fiber element wire 1 is heated at 45° C. for 3 minutes or more. In this case, it is possible to make the void V to disappear at a lower temperature. Therefore, it is possible to suppress an increase in transmission loss of the optical fiber element wire 1 more reliably.

Also, the Young's modulus of the secondary layer 20 is within the range of 750 to 2000 MPa. Even in this case, it is possible to suppress an increase in transmission loss of the optical fiber element wire 1 by setting the Young's modulus of the primary layer 10 within the above-described range.

Also, a manufacturing method of the optical fiber ribbon according to one or more embodiments involves preparing the plurality of optical fiber element wires 1 described above, applying a ribbon forming material to the plurality of optical fiber element wires 1, and integrating the plurality of optical fiber element wires 1 into a ribbon shape by heating and curing the ribbon forming material. According to this configuration, the void V disappears when heat is applied to the optical fiber element wires 1, and it is possible to manufacture an optical fiber ribbon in which transmission loss is suppressed.

Note that, the technical scope of the present invention is not limited to the above-described embodiments, and various modifications may be made in a range not departing from the spirit of the present invention.

For example, the optical fiber element wire 1 may have three or more coating layers. That is, yet another coating layer may be provided around the secondary layer (second coating layer) 20. Also, in order to ensure the adhesive strength between the bare wire part 30 and the primary layer 10, an adhesive layer may be provided between the bare wire part 30 and the primary layer 10.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Optical fiber element wire
10 Primary layer
20 Secondary layer
30 Bare wire part
V Void
Z Axial direction

1. An optical fiber element wire comprising:
a bare wire part comprising a core and a cladding and extending in an axial direction of the bare wire part;
a primary layer covering the bare wire part; and
a secondary layer covering the primary layer, wherein
a Young's modulus of the primary layer is within a predetermined range that removes a void within the primary layer in response to the optical fiber element wire being heated at either 45° C. or 60° C. for 3 minutes or more.

2. The optical fiber element wire according to claim 1, wherein the predetermined range of the Young's modulus removes the void in response to the optical fiber element wire being heated at 45° C. for 3 minutes or more.

3. The optical fiber element wire according to claim 1, wherein a Young's modulus of the secondary layer is within a range of 750 to 2000 MPa.

4. The optical fiber element wire according to claim 1, wherein a dimension of the void in the axial direction is three times or less a dimension of the void in a radial direction of the bare wire part that is perpendicular to the axial direction.

5. A manufacturing method of an optical fiber ribbon comprising:
applying a ribbon forming material to optical fiber element wires, each of which is the optical fiber element wire according to claim 1; and
integrating the optical fiber element wires into a ribbon shape by heating and curing the ribbon forming material.

6. The optical fiber element wire according to claim 1, wherein the predetermined range of the Young's modulus of the primary layer is within a range of 0.10 to 0.25 MPa.

7. The optical fiber element wire according to claim 1, wherein an outer diameter of the bare wire part is 100 μm or less.

8. The optical fiber element wire according to claim 7, wherein the outer diameter of the bare wire part is 80 μm or less.

9. The optical fiber element wire according to claim 1, wherein an outer diameter of the optical fiber element wire is 203 μm or less.

10. The optical fiber element wire according to claim 9, wherein the outer diameter of the optical fiber element wire is 193 μm or less.

11. The optical fiber element wire according to claim 10, wherein the outer diameter of the optical fiber element wire is 185 μm or less.

12. The optical fiber element wire according to claim 6, wherein the predetermined range of the Young's modulus of the primary layer is within a range of 0.10 to 0.17 MPa.

13. The optical fiber element wire according to claim 1, wherein a thickness of the primary layer is within a range of 11 to 22 μm.

14. The optical fiber element wire according to claim 13, wherein the thickness of the primary layer is within a range of 13 to 19 μm.

15. The optical fiber element wire according to claim 3, wherein the Young's modulus of the secondary layer is within a range of 750 to 1400 MPa.

16. The optical fiber element wire according to claim 1, wherein a glass transition temperature of the secondary layer is within a range of 60 to 110° C.

17. The optical fiber element wire according to claim 16, wherein the glass transition temperature of the secondary layer is within a range of 70 to 100° C.
